(19) United States
(12) Patent Application Publication
(10) Pub. No.: US 2005/0117588 A1
(43) Pub. Date: Jun. 2, 2005

(54) System and method for network address port translation

(76) Inventors: Kuo-Kun Tseng, QingShui Township (TW); Chia-Ren Hsu, Chiayi City (TW); Ying-Dar Lin, Hsinchu City (TW); Chien Chen, Hsinchu City (TW); Chih-Sheng Chang, Taipei City (TW); Po-Cheng Wu, Taipei City (TW); Wumin Chen, Hemei Township (TW); Chiuan-Yu Wei, Fengshan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/918,977

(22) Filed: Aug. 16, 2004

(30) Foreign Application Priority Data
Nov. 27, 2003 (TW) 92133296

(51) Int. Cl. H04L 12/28

(52) U.S. Cl. 370/395.31; 370/392

(57) ABSTRACT

A system for network address port translation. The system comprises a storage device and a translation module. The storage device stores a plurality of private address tables and a private port table, wherein each private address table and private port table comprises at least one entry, and each entry is assigned an index number. The translation module, connected to the storage device, receives a private IP address and a private port number, wherein the private IP address comprises a plurality of private address subsets, stores the private address subsets and private port number as entries in the private address tables and the private port table, respectively, and translates the private IP address and port number to and from a public port number, wherein the public port number comprises a plurality of public port subsets corresponding to the index numbers in the private address tables and the private port table.

### BACKGROUND OF THE INVENTION

1. Field of the Invention

The present invention relates to network communication and particularly to a system and method for network address port translation.

2. Description of the Related Art

Network address port translation, referred to as NAPT, is a virtual Internet Protocol (IP) address translation. Generally, NAPT is implemented in a network gateway apparatus such as a firewall device or a router. NAPT enables a plurality of devices connected to a local network to share a public Internet Protocol (IP) address, wherein each device uses a unique public port for Internet communication. Each device is assigned a private IP address, and each connection for a specific device uses a unique private port number.

According to Internet Protocol version 4 (IPv4), an IP address is a 32-bit numeric address written as four numbers separated by periods. Each number can be zero to 255. Every machine on the Internet has a unique identifying number, called an IP Address. A typical IP address looks like this:
216.27.61.137

To make the address format easier to remember, IP addresses are typically expressed in decimal format as a “dotted decimal number” as above. Computers, however, communicate in binary form. Below is the same IP address in binary format:
11011000.00011011.00111101.10001001

The four numbers in an IP address are called octets, because each of them has eight positions when viewed in binary form. If you add all the positions together, you get 32, which is why IP addresses are considered 32-bit numbers.

Conventionally, a public port number for a device is generated using the private IP address and private port number thereof. The conventional method for generating public port numbers requires a table storing all private IP address within a local network. An IP address has two parts, an identifier of a particular network on the Internet and an identifier of a particular device (which can be a server or a workstation) within the network. Within a middle-size local network, private addresses for all devices share the same values in the first two octets. Private addresses for different devices have different values only in the last octet or the last two octets. For example, a conventional NAPT method generates a public port number by combining part of the corresponding private port number with the fourth octet of the corresponding private IP address. According to this method, a table is required to store a complete private IP address for each device within the local network, that is, the four octets for each private IP address are stored. When a network is a class C network, the first three octets are the same throughout the network, while the last octet has different values for different devices. Therefore, the aforementioned table repeatedly stores values for the first three octets, and thus causes redundancy.

Hence, there is a need for a network address port translation system that addresses the problems arising from the existing technology.

### SUMMARY OF THE INVENTION

It is therefore an object of the invention to provide a system and method for network address port translation to enhance flexibility and reduce storage requirement. To achieve this and other objects, the present invention provides a system and method for network address port translation.

According to the invention, a method for network address port translation is provided within a network address port translation device. First, a plurality of private address tables and a private port table are provided, wherein each of private address table and private port table comprises at least one entry, respectively. Each entry is assigned an index number. Second, a private address and a private port number are provided, wherein the private IP address comprises a plurality of private address subsets. The private address subset is then stored in the private address tables, wherein each private address subset is stored in one of the private address tables as an entry. The private port number is then stored in the private port table as an entry. The private IP address and private port number is then translated to and from a public port number, wherein the public port number comprises a plurality of public port subsets corresponding to the index numbers in the private address tables and the private port table.

The invention also provides a system for network address port translation. The system comprises a storage device and a translation module. The storage device stores a plurality of private address tables and a private port table, wherein each private address table and private port table comprises at least one entry, and each entry is assigned an index number. The translation module, connected to the storage device, receives a private IP address and a private port number, wherein the private IP address comprises a plurality of private address subsets, stores the private address subsets and private port number as entries in the private address tables and the private port table, respectively, and translates the private IP address and port number to and from a public port number, wherein the public port number comprises a plurality of public port subsets corresponding to the index numbers in the private address tables and the private port table.

The above-mentioned method may take the form of program code embodied in a computer readable tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a network system according to the present invention;

FIG. 2 is a block diagram of a NAPT device according to the present invention;

FIGS. 3A and 3B are flowcharts of a NAPT method for an outgoing packet according to the present invention;

FIG. 4 illustrates private IP address tables, a private port table, and corresponding public port number according to the present invention;

FIG. 5 is a flowchart of a NAPT method for an incoming packet according to the present invention; and

FIG. 6 is a diagram of a storage medium storing a computer program providing the network address port translation method of the present invention.

### DETAILED DESCRIPTION

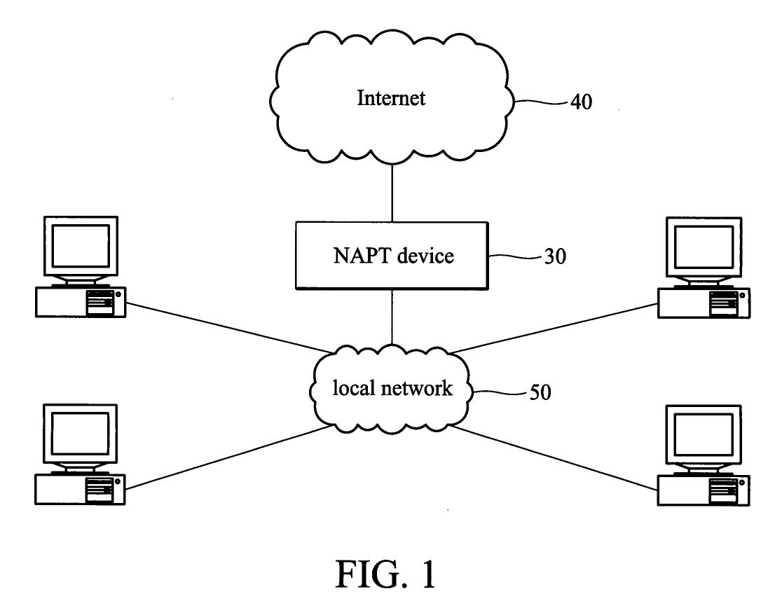

The present invention will now be described with reference to FIGS. 1 to 6, which in general relate to a system for network address port translation.

FIG. 1 is a schematic view of a network system according to the present invention. Using FIG. 1 as an example, a network system comprises an Internet 40, a NAPT device 30, and a local network 50. The NAPT device 30 is connected to the local network 50 and the Internet 40. The NAPT device 30 is assigned a public address by an Internet Service Provider. The NAPT device 30 translates a private IP address and port number to and from a public port number, thus every device of the local network 50 can communicate with the Internet 40 using an assigned private IP address and a private port number.

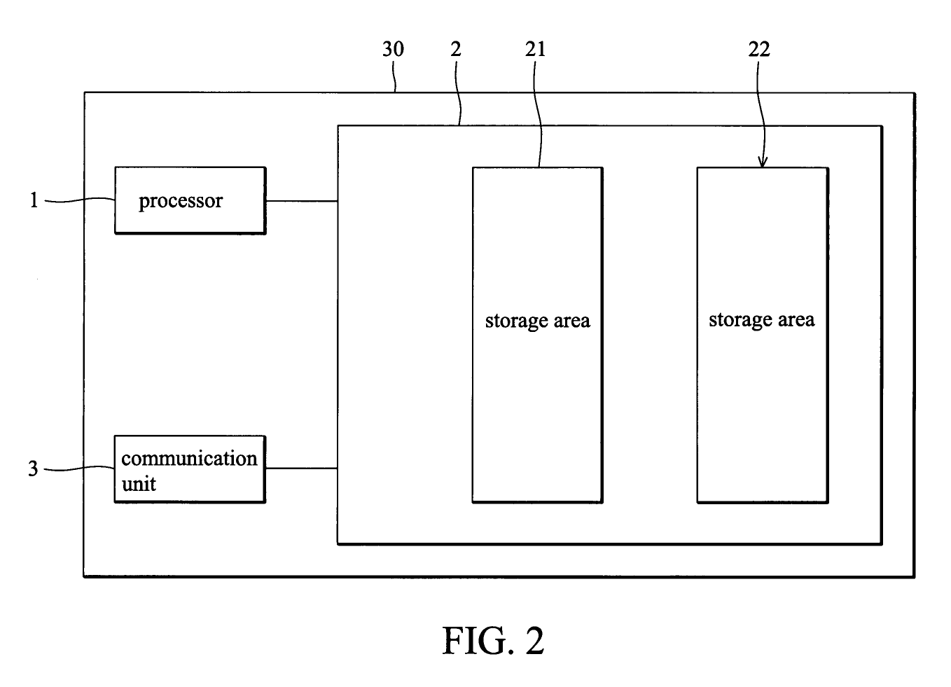

Referring to FIG. 2, the NAPT device 30 comprises a processor 1, a storage unit 2, and a communication unit 3. The processor 1 is connected to the storage unit 2 and the communication unit 3. The communication unit 3 receives and transmits packets.

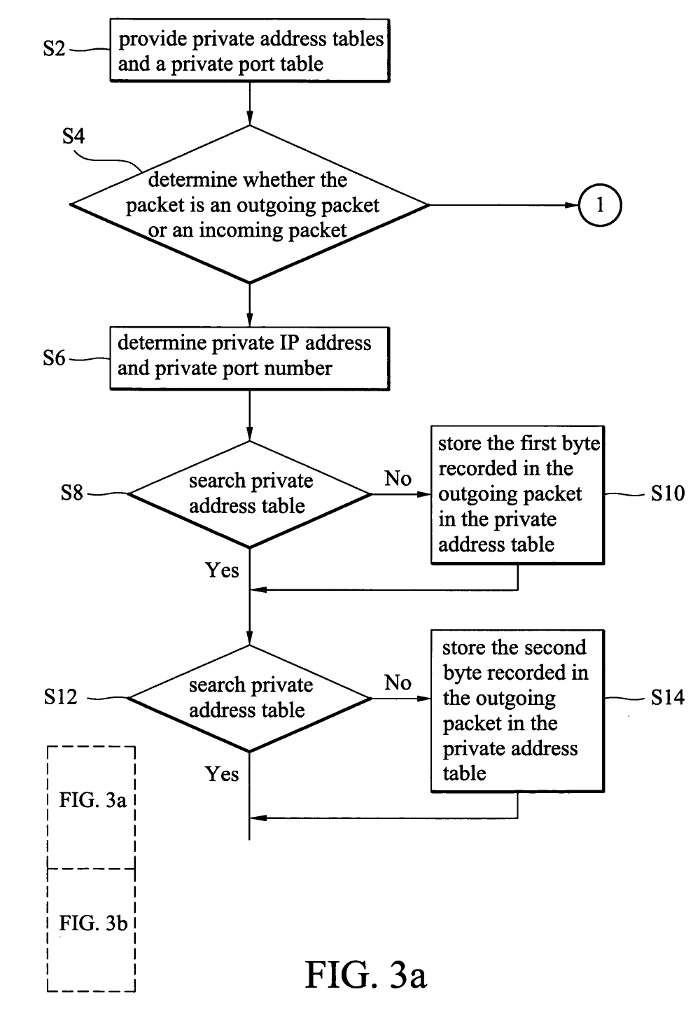

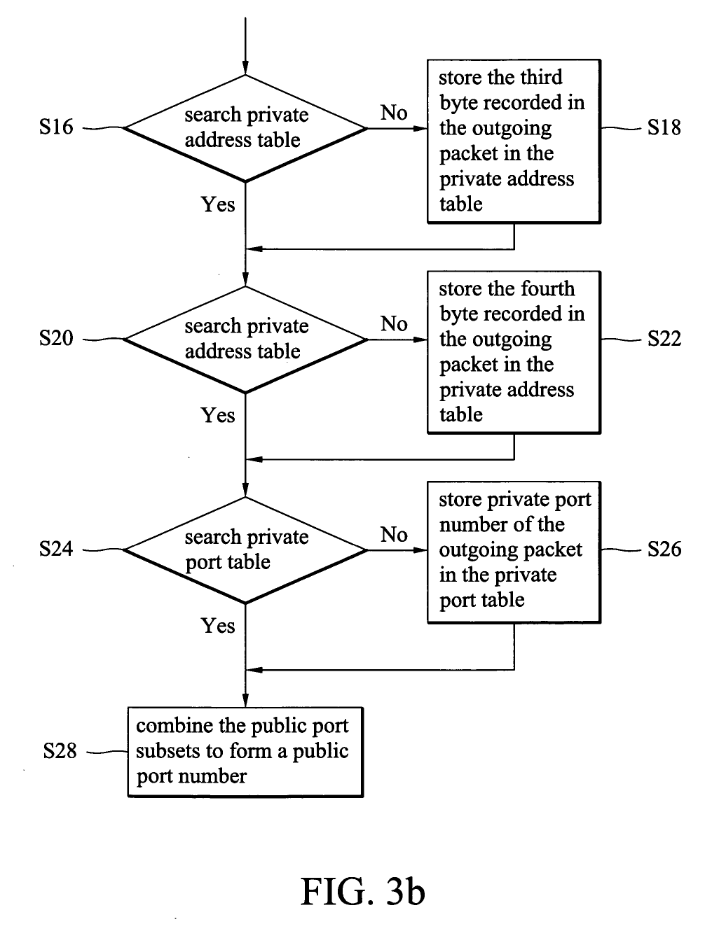

FIGS. 3A and 3B are flowcharts of a NAPT method for an outgoing packet according to the present invention.

First, a plurality of private address tables and a private port table are provided and stored in the storage device 2 by a system manager or a NAPT manufacturer (step S2). Each of the private address tables and private port table comprises at least one entry. The number of private address tables, entries in the private address table and private port table, and formats of the tables are defined when the tables are provided. Additionally, a private IP address is divided into a plurality of private address subsets, wherein each private address subset comprises a preset number of bits. A public port number is divided into a plurality of public port subsets, wherein each public port subset comprises a preset number of bits. According to a preferred embodiment of the present invention, the storage device 2 comprises storage area 21 storing private address tables 681, 682, 683, 684, and a private port table 69.

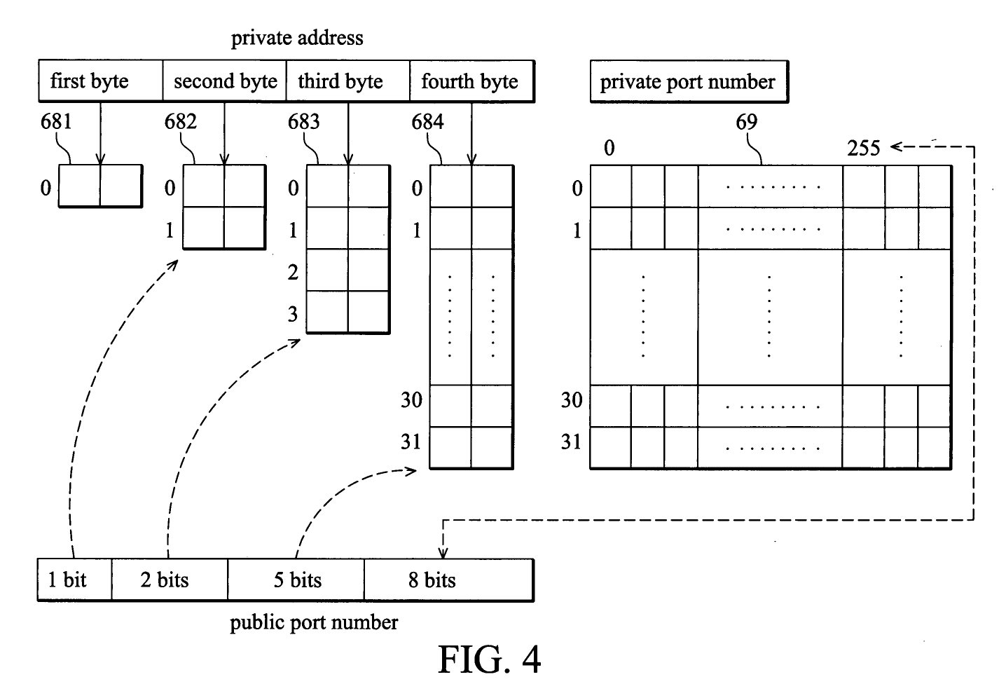

Referring to FIG. 4, the private address tables 681, 682, 683, and 684 comprise 2⁰, 2¹, 2², 2⁵ entries, respectively. Each entry is assigned an index number. According to the embodiment, the private port table 69 is a 2-dimensional table comprising 32 rows and 256 columns, wherein the row index number ranges from 0 to 31, and the column index number ranges from 0 to 255.

The network system of the embodiment operates according to Ipv4. Therefore, each device within the network is assigned a 32-bit private IP address, a 16-bit private port number, a 32-bit public address, and a 16-bit public port number.

The private IP address is divided into 4 private address subsets, and each of them corresponds to an octet of the private IP address. Therefore, the first octet comprises the first bit to eighth bit, the second octet comprises the ninth bit to sixteenth bit, the third octet comprises the seventeenth bit to twenty-fourth bit, and the fourth octet comprises the twenty-fifth bit to the thirty-second bit.

The public port number is divided into 4 public port subsets comprising 1, 2, 5, and 8 bits, respectively. Therefore, the first public port subset comprises the first bit of the public port number, the second public port subset comprises the second and third bits, the third public port subset comprises the fourth to eighth bits, and the fourth public port subset comprises the ninth to sixteenth bits.

When a packet is transmitted to the NAPT device, it is transferred from the communication unit 3 to the processor 1. It is then determined whether the packet is an outgoing packet or an incoming packet (step S4).

When an outgoing packet is received, a source address of the packet is retrieved and assigned as a private IP address, and a source port number thereof is retrieved and assigned as a private port number (step S6). The private address tables 681, 682, 683, and 684 are searched to find entries having values equaling the first, second, third, and fourth private address subsets, respectively. The private port table 69 is searched to find entries having values equaling the private port number. When matched entries for the private address subsets and the private port number are not obtained, a new connection is then established. And the private IP address and the private port number of the outgoing packet are stored in corresponding private address tables and private port table to establish a connection thereof.

First, the private address table 681 is searched to find values equaling the first private address subset (step S8). If a match for the first private address subset does not exist, a first byte recorded in the outgoing packet is retrieved and stored in the private address table 681 (step S10). The private address tables 682, 683, and 684 are searched to find values equaling the second, third, and fourth private address subsets, respectively (steps S12, S16, and S20). Similarly, if matches for the second, third, and fourth private address subsets do not exist, the second, third, and fourth bytes recorded in the outgoing packet are retrieved and stored in the private address tables 682, 683, and 684, respectively (steps S14, S18, and S22). Each value in the private address tables 681, 682, 683, and 684 fits in an entry thereof and is assigned an index number.

A specific row in the private port table 69 is searched to find values equaling the private port number. The specific row has a row index number equaling the index number corresponding to the fourth private address subset (step S24). If a match for the private port number doesn't exist, the private port number of the outgoing packet is then retrieved and stored in the private port table 69 (step S26).

For an established connection, the four private address subsets of its private IP address are stored in private address tables 681, 682, 683, and 684, respectively; the private port number thereof is stored in a specific row of the private port table 69.

The index number corresponding to the first private address subset is retrieved and assigned as a first public port subset, wherein the first public port subset comprises 1 bit. Similarly, the index numbers corresponding to the second, third, and fourth private address subsets are retrieved and assigned as second, third, and fourth public port subsets, respectively. The second, third, and fourth public port subsets comprise 2, 5, and 8 bits, respectively. The first, second, third, and fourth public port subsets are then combined to form a public port number accordingly (step S28).

The public port number of the outgoing packet is substituted for private port number, and the public address. The outgoing packet is then transmitted to Internet 40 via the communication unit 3.

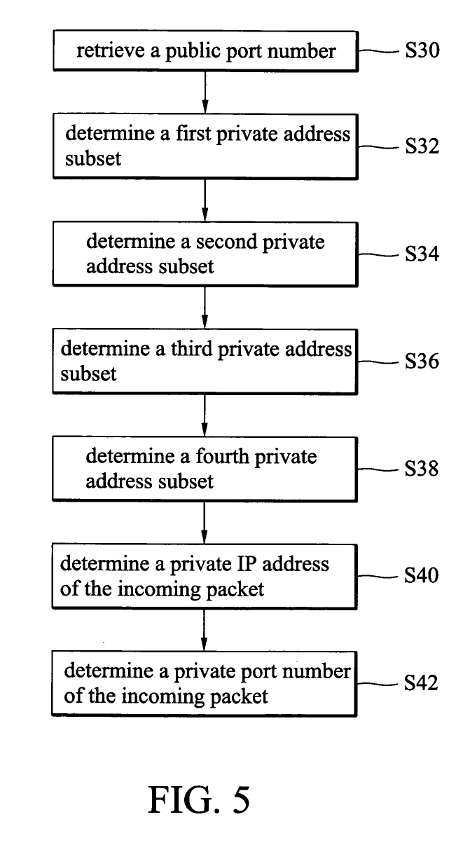

FIG. 5 is a flowchart of a NAPT method for an incoming packet according to the present invention. First, a public port number recorded in the incoming packet is retrieved (step S30). The public port number is divided into 4 public port subsets. The value stored in the only entry in the private address table 681 is assigned as a first private address subset (step S32). The value of the first public port subset is used as an index number to retrieve a corresponding value in the private address table 682. The corresponding value in the private address table 682 is assigned as a second private address subset (step S34). Similarly, the second and third public port subsets are used to determine the third and fourth private address subsets by searching private address tables 683 and 684 (steps S36 and S38). The values corresponding to the first, second, and third public port subsets are combined to form a private IP address of the incoming packet (step S40).

The value of the fourth public port subset and an index number corresponding to the third public port subset are used as index numbers to retrieve a corresponding value in the private port table 69. The index number corresponding to the third public port subset is used as a row index number in the search process, and the index number corresponding to the fourth public port subset as a column index number. The corresponding value in the private port table 69 is assigned as a private port number (step S42).

The private port number and private IP address number of the incoming packet is substituted for public port number. The incoming packet is then transmitted to local network 50 through the communication unit 3.

The data retrieval from the private address and port tables can be accelerated by a hashing process. Characters stored in the private address tables and the private port table can be used as hash keys. A hash function is provided to index the original value and then used later each time the data associated with the value is to be retrieved. When a hash collision occurs, rehashing or open linear probing is performed to produce different hash values for different inputs.

The number of hashing collisions can be limited by setting a maximum collision limit in advance. When number of hashing collisions exceeds the preset maximum collision limit, a new connection is established.

The data retrieval from the private address and port tables can be accelerated by using an unused bit array. The unused bit array, stored in a register, is used to label the utilization of the private address and port tables. Each bit in the unused bit array indicates the utilization of a corresponding field of the private address and port tables. For example, an unused field corresponds to a bit equaling 0, and a used field corresponds to a bit equaling 1. The unused bit array is checked before the search process is performed. The unused fields are then skipped in the search process according to the corresponding values in the unused bit array.

The data retrieval from the private address and port tables can be accelerated by using a cache memory. Caching improves lookup speeds by taking advantage of the locality in the traffic. A recently used table is established in a cache memory to store recently used private IP addresses, private port numbers, and corresponding public port numbers. Before an outgoing packet is transmitted, the recently used table is searched for a matched private IP address and private port number. If a matche exists for the private IP address and the private port number of the outgoing packet, then a corresponding public port number can be determined according to the recently used table. Similarly, before an incoming packet is transmitted, the recently used table is searched for matches for the public port number. If there are matches for the public port number of the incoming packet, then a corresponding private address and port number can be determined according to the recently used table.

The private address and port tables can be reconfigured to meet requirements. Each entry in the private address table comprises 2 bits, and each entry in the private port table comprises 4 bits. For example, a public port number is divided into 5 public port subsets, comprising n1, n2, n3, n4, and n5 bits, respectively. Accordingly, corresponding private address tables 681, 682, 683, and 684 comprise 2ⁿ¹, 2ⁿ², 2ⁿ³, and 2ⁿ⁴ entries, respectively, and corresponding private port table 69 is a 2ⁿ⁵×2ⁿ⁴ table comprising 2ⁿ⁵×2ⁿ⁴ entries.

The method for network address port translation implemented in the system for network address port translation of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

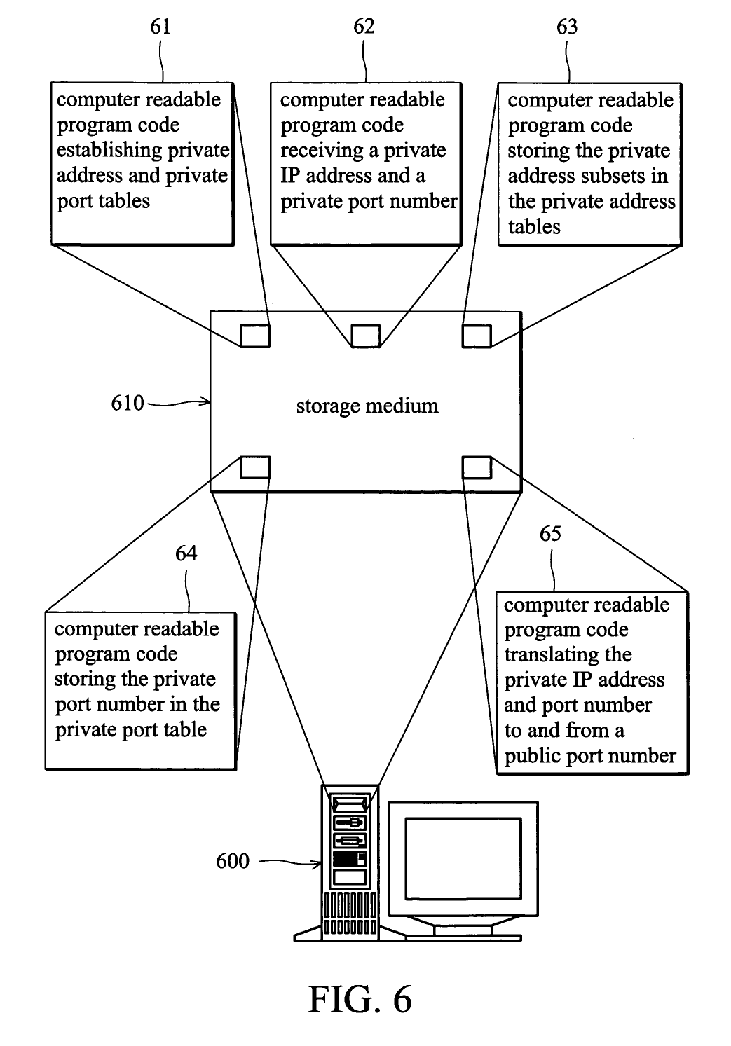

FIG. 6 is a schematic diagram of a storage medium for a computer program providing the method for network address port translation according to the present invention. The computer program product includes a storage medium 610 having computer readable program code embodied in the medium for use in a computer system 600, the computer readable program code comprising at least computer readable program code 61 establishing a plurality of private address tables and a private port table, computer readable program code 62 receiving a private IP address and a private port number, computer readable program code 63 storing the private address subsets in the private address tables, computer readable program code 64 storing the private port number in the private port table as the entry, and computer readable program code 65 translating the private IP address and port number to and from a public port number.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for network address port translation, comprising:
establishing a plurality of private address tables and a private port table, wherein each of the private address tables and private port table comprises at least one entry, respectively, and each entry is assigned an index number;
providing a private IP address and a private port number, wherein the private IP address comprises a plurality of private address subsets;
storing the private address subsets in the private address tables, wherein each private address subset is stored in one of the private address tables as the entry;
storing the private port number in the private port table as the entry; and
translating the private IP address and port number to and from a public port number, wherein the public port number comprises a plurality of public port subsets corresponding to the index numbers in the private address tables and the private port table.

2. The method of claim 1, wherein the private port table is a 2-dimensional table comprising fields for storing private port numbers.

3. The method of claim 1, wherein the private address subset comprises n bits, wherein 4≦n≦16.

4. The method of claim 1, wherein the private IP address comprises k private address subsets stored as corresponding entries in the private address tables.

5. The method of claim 4, wherein the private port table is a 2-dimensional table comprising fields for storing private port numbers, and each private port number corresponds to a row and column index numbers.

6. The method of claim 1, wherein the public port number subsets comprise m₁, m₂, . . . , mᵢ₊₁ bits, and the m₁, m₂, . . . , mᵢ₊₁ are integers larger than or equal to zero, and the corresponding private address tables have 2^{m1}, 2^{m2}, . . . , 2^{mi} entries.

7. The method of claim 1, wherein the private port table is a 2^{mi}×2^{mi+1} table.

8. The method of claim 1, further resetting at least one of the private address subset, number of entries thereof, and the private port subset.

9. The method of claim 1, further searching the private address table and the private port table before translating the private IP address and the private port number into the public port number.

10. The method of claim 9, wherein the search step further performs a hashing process.

11. The method of claim 10, wherein the hashing process specifies a maximum collision limit to limit the number of hashing collisions.

12. The method of claim 9, wherein the search step further utilizes an unused bit array for specifying utilization of the fields in the private address and port tables.

13. The method of claim 12, wherein the search step selectively searches utilized fields according to the unused bit array.

14. The method of claim 9, wherein the search step further searches a table storing recently utilized private IP addresses, private port numbers, and public port numbers.

15. The method of claim 9, wherein the address and port translation is used for translating a public port number to a corresponding private IP address and port number.

16. A system for network address port translation, comprising:
a storage device, storing a plurality of private address tables and a private port table, wherein each of the private address tables and private port table comprises at least one entry, respectively, and each entry is assigned an index number; and
a translation module, connected to the storage device, receiving a private IP address and a private port number, wherein the private IP address comprises a plurality of private address subsets; storing the private address subsets and private port numbers as entries in the private address tables and the private port table, respectively, and translating the private IP address and port number to and from a public port number, wherein the public port number comprises a plurality of public port subsets corresponding to the index numbers in the private address tables and the private port table.

17. The system of claim 16, wherein the private port table is a 2-dimensional table comprising fields for storing private port numbers.

18. The system of claim 17, wherein the private address subset comprises n bits, wherein 4≦n≦16.

19. The system of claim 17, wherein the private IP address comprises k private address subsets stored as corresponding entries in the private address tables.

20. The system of claim 19, wherein the private port table is a 2-dimensional table comprising fields for storing private port numbers, and each private port number corresponds to a row and column index numbers.

21. The system of claim 16, wherein the public port number subsets comprise m₁, m₂, . . . , mᵢ₊₁ bits, and the m₁, m₂, . . . , mᵢ₊₁ are integers larger than or equal to zero, and the corresponding private address tables have 2^{m1}, 2^{m2}, . . . 2^{mi} entries.

22. The system of claim 16, wherein the port table is a 2^{mi}×2^{mi+1} table.

23. The system of claim 16, wherein the translation module further resets at least one of the private address subset, number of entries thereof, and the private port subset.

24. The system of claim 16, wherein the translation module further searches the private address table and the private port table before translating the private IP address and the private port number into the public port number.

25. The system of claim 24, wherein the translation module further performs a hashing process.

26. The system of claim 25, wherein the translation module further specifies a maximum collision limit to limit the number of hashing collisions.

27. The system of claim 24, wherein the translation module performs the search step utilizing an unused bit array for specifying utilization of the fields in the private address and port tables.

28. The system of claim 27, wherein the translation module selectively searches utilized fields according to the unused bit array.

29. The system of claim 25, wherein the translation module further searches a table storing recently utilized private IP addresses, private port numbers, and public port numbers.

30. The system of claim 24, wherein the translation module translates a public port number to a corresponding private IP address and port number.

31. A computer readable storage medium for storing a computer program providing a method for network address port translation, the method comprising:
establishing a plurality of private address tables and a private port table, wherein each of the private address tables and private port table comprises at least one entry, respectively, and each entry is assigned an index number;
receiving a private IP address and a private port number, wherein the private IP address comprises a plurality of private address subsets;
storing the private address subsets in the private address tables, wherein each private address subset is stored in one of the private address tables as the entry;
storing the private port number in the private port table as the entry; and
translating the private IP address and port number to and from a public port number, wherein the public port number comprises a plurality of public port subsets corresponding to the index numbers in the private address tables and the private port table.

32. The storage medium of claim 31, wherein the private port table is a 2-dimensional table comprising fields for storing private port numbers.

33. The storage medium of claim 31, wherein the private address subset comprises n bits, wherein 4≦n≦16.

34. The storage medium of claim 31, wherein the private IP address comprises k private address subsets stored as corresponding entries in the private address tables.

35. The storage medium of claim 34, wherein the private port table is a 2-dimension table comprising fields for storing private port numbers, and each private port number corresponds to a row and column index numbers.

36. The storage medium of claim 31, wherein the public port number subsets comprise m₁, m₂, . . . , mᵢ₊₁ bits, and the m₁, m₂, . . . , mᵢ₊₁ are integers larger than or equal to zero, and the corresponding private address tables have 2^{m}, 2^{m2}, . . . , 2^{mi} entries.

37. The storage medium of claim 31, wherein the private port table is a 2^{mi}×2^{mi+1} table.

38. The storage medium of claim 31, further resetting at least one of the private address subset, number of entries thereof, and the private port subset.

39. The storage medium of claim 31, further searching the private address table and the private port table before translating the private IP address and the private port number into the public port number.

40. The storage medium of claim 39, wherein the search step further performs a hashing process.

41. The storage medium of claim 40, wherein the hashing process specifies a maximum collision limit to limit the number of hashing collisions.

42. The storage medium of claim 39, wherein the search step further utilizes an unused bit array for specifying utilization of the fields in the private address and port tables.

43. The storage medium of claim 42, wherein the search step selectively searches utilized fields according to the unused bit array.

44. The storage medium of claim 39, wherein the search step further searches a table storing recently utilized private IP addresses, private port numbers, and public port numbers.

45. The storage medium of claim 39, wherein the address and port translation is used for translating a public port number to a corresponding private IP address and port number.
